(19) United States
(12) Patent Application Publication
(10) Pub. No.: US 2007/0090148 A1
(43) Pub. Date: Apr. 26, 2007

(54) Coil nailer for construction finish material

(75) Inventors: Bo-Seob Cho, Seoul (KR); Gil-Sub Song, Incheon (KR); Jae-Sung Kim, Seoul (KR); In-Sung Hwang, Incheon (KR); Myung-Kyun Kim, Seoul (KR); Sang-Chun Lee, Seongnam (KR); Jong-Yeol Han, Seongnam (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: JEIL TACKER CO., LTD.

(21) Appl. No.: 11/255,294

(22) Filed: Oct. 20, 2005

(51) Int. Cl. B25C 5/00

(52) U.S. Cl. 227/137

(57) ABSTRACT

A coil nailer aligns the releasing direction of a door latch with the door opening and closing direction such that a door latch is released to open the door by one touch of a left hand thumb, a contact arm is easily coupled with and separated from a contactor to prevent the contact arm from separating from the contactor and to easily exchange the contactor, a guide device in a magazine filled with various sized nails is moved to precisely guide the nails, and a measuring device measuring intervals between shingles is attached to the magazine such that the shingles are positioned at predetermined intervals without a separate measuring device. Since the plate supporting nails is lowered or lifted according to lengths of the nails, the nails can be effectively guided, the interval between lower and upper waterproof sheets can be measured when attaching shingles and waterproof sheets.

### BACKGROUND OF THE INVENTION

1. Field of the Invention

The present invention relates to a coil nailer, and more particularly, to a coil nailer in which the releasing direction of a door latch is aligned with the door opening and closing direction such that the door latch is released to open the door by one touch of a left hand thumb, a contact arm is easily coupled with and separated from a contactor such that the contact arm is not separated from the contactor and the contactor is easily exchanged, a guide device in a magazine filled with various sized nails is moved to precisely guide the nails, and a measuring device for measuring intervals between shingles is attached to the lower side of the magazine such that the shingles are positioned at predetermined intervals without a separate measuring device.

2. Description of the Related Art

As is well-known, a tacker, used in constructing buildings and in interior construction, is a pneumatic device, such as a nailer, a stapler, and a pinner that are used in joining wood to wood, wood to plastic, wood to steel, and wood to concrete, and is used in various constructions such as interior and exterior decoration of buildings, installation of aluminum sashes, or the like.

General working principles of the tackers are almost identical to each other, but structures of the nailer, the stapler, and the pinner are slightly different from each other.

A general coil nailer 2, as shown in FIG. 1, includes a body 4 in which a piston and a cylinder are installed, a handle 6 installed to the lower side of the body 4 and grasped by a hand and having a supply passage for supplying air to the piston, a magazine 10, installed to the front lower side of the body 4, in which nails, staples, or pins are loaded, and a standby part 12 for receiving the nails, staples, or the pins loaded in the magazine 10 and for keeping the nails, the staples, or the pins for firing through a muzzle 14 positioned at the front side of the body 4.

Moreover, the coil nailer 2 further includes a door 16 installed at the lower side of the front standby part 12 of the body 4 and opened to visually check the nails, the staples, or the pins supplied from the magazine 10, a door latch 20 for keeping the door 16 closed, a hinge shaft 18 coupled with a lateral side of the front muzzle 14 of the body 4 by a shaft to open the door 16.

As such, according to the conventional coil nailer, since a plurality of nails (not shown) is welded in the magazine 10 by a coil and is supplied to the muzzle 14, a worker must change the door 16 to an opening mode using the door latch 20, to open the door 16 by a predetermined angle and to check the state of the nails loaded therein.

However, in the conventional coil nailer, since the door latch 20 of nailer has a structure wherein the door 16 is opened when the worker grasps the handle with the right hand, holds the door latch 20 with a right thumb and a right forefinger, and lifts the door latch 20 up while pushing the door latch 20 toward the muzzle 14, the direction of opening the door 16 is different from the direction of releasing the door 16 using the door latch 20.

In other words, since, in order to open the door 16, only when the worker of the conventional coil nailer pushes the door latch 20 to the front side to release the door latch 20, pushes the door latch 20 to the front side to open the door 16, and lifts the door latch 20 up, is the door 16 opened, two different actions must be simultaneously carried out to open the door 16. Since the releasing direction of the door latch 20 is aligned with the direction of the muzzle 14, recoil may cause the door latch 20 to be released.

Moreover, since an internal structure of the magazine 10 of the conventional coil nailer 2 can only accommodate nails having a predetermined length, in order to use other nails having a different length, the worker must use another coil nailer 2 for accommodating the other nails. In the case of loading and using smaller nails than those for which the magazine 10 was designed, the nails lifted from the inside of the magazine 10 to the front standby part 12 cannot be smoothly guided.

Additionally, the conventional coil nailer 2 is uses in finish work such as shingling. Shingling is the process of attaching partially laminated waterproof sheets on a slant outer surface of a roof at predetermined intervals.

Until today, shingling has been carried out in the following manner. First, the worker holds a measuring device such as a scale with one hand and measures the interval between a lower waterproof sheet and an upper waterproof sheet to which a part of the upper side of the lower waterproof sheet is attached so as to precisely attach any one sheet in the horizontal direction.

However, in shingling carried out in the above-mentioned way, since another worker holds the coil nailer 2 with one hand and holds the measuring device with the other hand, nailing is carried out using only the other hand with the coil nailer 2. Thus, the conventional coil nailer is difficult to use and the worker may fail to hold the coil nailer 2 with one hand and may drop the coil nailer 2. Particularly, when dropping the coil nailer 2 during roofing using a conventional coil nailer 2, there is a high risk of injury to other workers.

Meanwhile, the conventional coil nailer 2 includes a contact arm installed in the longitudinal direction of the body 4 and the contactor contacting an actual striking spot installed in the front side thereof, wherein the contact arm and the contactor are coupled by bolts and welding.

However, since the contactor employed in the conventional coil nailer 2 contacts the striking spot so frequently that the front side thereof is easily worn, the bolts must be released and the welded spots must be separated during the replacement of the contactor after use for a predetermined period of time. Thus, the replacement of the contactor is complicated.

### SUMMARY OF THE INVENTION

Therefore, the present invention has been made in view of the above and/or other problems, and it is an object of the present invention to provide a coil nailer in which the releasing direction of a door latch is aligned with the opening and closing direction of a door such that the door latch is released simultaneously with opening the door, the releasing direction of the door latch is perpendicular to the recoil direction of the coil nailer such that the door is prevented from being opened due to the recoil force, thereby minimizing risk of various accidents and enhancing convenience.

It is another object of the present invention to provide a coil nailer in which a contact arm is easily coupled with and separated from a contactor and, after the coupling, the contact arm is not separated from the contactor so that the contactor is easily replaced.

It is still another object of the present invention to provide a coil nailer in which various-sized nails loaded in a magazine are precisely guided by moving a guide, and a measuring device is installed to the lower side of the magazine to measure intervals between shingles so that a worker can carry out nailing using both hands.

In accordance with the present invention, the above and other objects can be accomplished by the provision of a coil nailer including: a body in which a piston and a cylinder are installed; a magazine including a supply passage for supplying air to the piston, a handle grasped by a hand, and a magazine, installed to the front lower side of the body, in which nails, staples, or pins are loaded; a standby part for receiving the nails, staples, or the pins loaded in the magazine and for keeping the nails, the staples, or the pins waiting for firing through a muzzle positioned at the front side of the body; a door installed at the lower side of the front standby part of the body and opened to visually check the nails, the staples, or the pins supplied from the magazine; and a door latch installed in the lower side of the door to lock a hook formed at the other end of the door latch with respect to a locking protrusion in order to keep the door closed; wherein a hinge shaft of the door latch is aligned with a hinge shaft of the door so that the operation direction of the door latch is identical to the opening and closing direction of the door and the release of the door latch and the opening of the door are simultaneously carried out.

In accordance with another aspect of the present invention, the above and other objects can be accomplished by the provision of a coil nailer including: a nose as a front member for guiding and firing nails and needles loaded therein; and a contactor coupled with a front outer circumference of the nose by the inside of a body of the contactor and including a coupling part of a contact arm positioned on the nose coupled with coupling grooves formed in the lateral sides of the contactor such that the contact is easily coupled and separated.

In accordance with the present invention, the above and other objects can be accomplished by the provision of a coil nailer including: a height adjustor for adjusting the height of an inner platform as a support for supporting nails according to the length of the nails loaded in a magazine so as to load and guide the nails regardless of the length of the nails; and a shingle interval measuring device for easily measuring distance between a lower shingle and an upper shingle when fastening the shingles as waterproof materials for a roof, wherein various sized nails are precisely loaded in the magazine and the intervals between the shingles or the shingles are easily adjusted.

### BRIEF DESCRIPTION OF THE DRAWINGS

These and/or other objects and advantages of the present invention will become apparent and more readily appreciated from the following description of the embodiments, taken in conjunction with the accompanying drawings, in which:

FIG. 1 is a perspective view illustrating a conventional coil nailer;

FIG. 2 is a perspective view illustrating a coil nailer according to a preferred embodiment of the present invention;

FIG. 3 is a detailed partial perspective view illustrating a door latch of the coil nailer according to the preferred embodiment of the present invention;

FIG. 4 is a perspective rear-side view illustrating the rear side of the door of the coil nailer according to the preferred embodiment of the present invention;

FIG. 5 is a view illustrating a coupling structure of a connector of the coil nailer according to the preferred embodiment of the present invention;

FIG. 6 is a perspective view illustrating the coupling structure of the connector of the coil nailer according to the preferred embodiment of the present invention;

FIG. 7 is a perspective view illustrating operation of the connector of the coil nailer according to the preferred embodiment of the present invention;

FIG. 8 is an exploded perspective view illustrating a magazine of the coil nailer according to the preferred embodiment of the present invention;

FIG. 9 is a partially enlarged perspective view illustrating a magazine post of the coil nailer according to the preferred embodiment of the present invention;

FIG. 10 is a bottom perspective view illustrating a coil supporting plate of the coil nailer according to the preferred embodiment of the present invention;

FIG. 11 is a partially cut-away perspective view illustrating a magazine of the coil nailer according to the preferred embodiment of the present invention;

FIG. 12 is an exploded perspective view illustrating a shingle-interval adjusting device of the coil nailer according to the preferred embodiment of the present invention; and

FIGS. 13a and 13b are views illustrating the use of the shingle-adjusting device of the coil nailer according to the present invention.

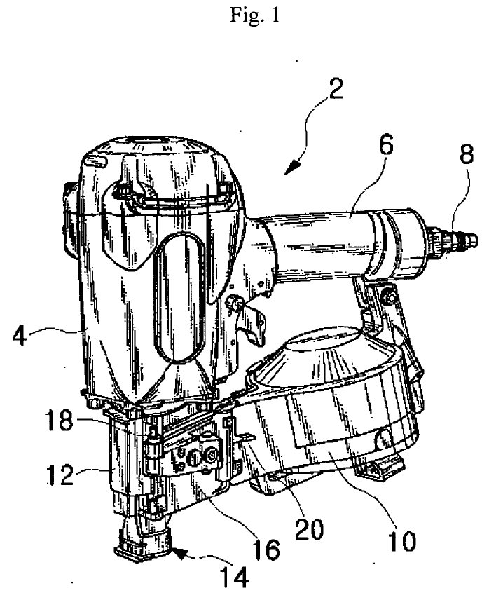

### DESCRIPTION OF THE PREFERRED EMBODIMENTS

Hereinafter, a coil nailer according to the preferred embodiment of the present invention will be described with reference to the accompanying drawings.

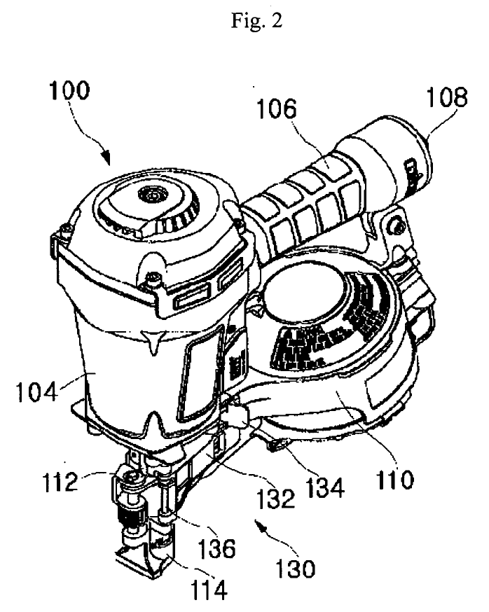

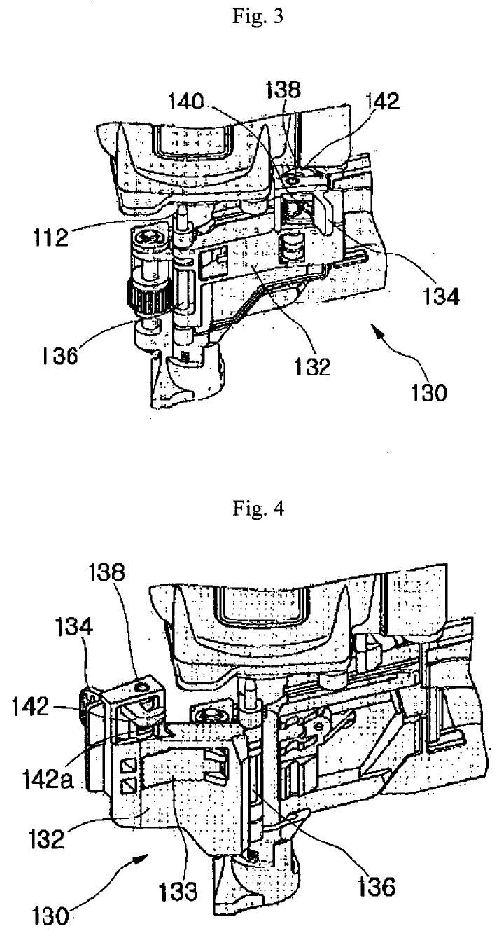

FIG. 2 is a perspective view illustrating a coil nailer according to the preferred embodiment of the present invention, FIG. 3 is a detailed partial perspective view illustrating a door latch of the coil nailer according to the preferred embodiment of the present invention, and FIG. 4 is a perspective rear-side view illustrating the rear side of the door of the coil nailer according to the preferred embodiment of the present invention.

As shown in the above respective drawings, the coil nailer 100 according to the preferred embodiment of the present invention has a structure wherein the releasing direction of a door latch is aligned with the opening and closing direction of a door such that the door latch is released simultaneously with opening the door, the releasing direction of the door latch is perpendicular to the recoil direction of the coil nailer such that the door is prevented from being opened due to recoil, thereby minimizing risk of various accidents and enhancing convenience.

In other words, the coil nailer 100 of the present invention is structured such that, although a door 132 employed in a door part 130 is opened and closed in the vertical direction as in the conventional coil nailer, a door latch 134, installed to the lower side of the door 132 to lock the door 132 when opening and closing the door 132, is operated in the direction identical to the opening and closing direction of the door 132 so that the door is opened and closed.

Moreover, in the present invention, since the door latch 134 is operated in the vertical direction, a door latch hinge shaft 138 of the door latch 134 and a hinge shaft of a check pawl (not shown), formed in the central portion of the door 132, through which whether nails are loaded is checked can be implemented by a single hinge shaft. Thus, the number of parts can be reduced.

In other words, when the lower side of the door latch 134 is pressed upwardly, a hook 142 formed at the other end of the door latch 134 is released from a locking protrusion (not shown), and when the door latch 134 is continuously pressed in the direction of opening the door latch 134, the door 32 is opened.

Thus, when the worker grasps the handle 106 of the nailer 100 with the right hand and pushes the lower side of the door latch 134 provided at the left front side of a body 104 by the thumb or the forefinger upwardly, as shown in FIG. 4, the hook 142 formed at the other end of the door latch 134 is released from the locking protrusion (not shown) and the door 132 can be opened.

In the state, the lower side of the door latch 134 is continuously pressed upwardly and the door 132 is opened upwardly.

Closing the door 132 is performed similarly to the opening of the door 132. In other words, when the worker grasps the handle 106 of the coil nailer 100 with the right hand and unlatches the door 132 provided at the left front side of the body 104, the door 132 rotates about the hinge shaft 136 due to gravity and the hook 142 of the door latch 134 closely contacts the locking protrusion (not shown).

In this state, when the worker presses the door 132 or the door latch 134 toward the body 104 with one of the thumb and the forefinger or palm, the hook 142 formed at the other end of the door latch 134 is locked by the locking protrusion (not shown), thereby closing the door 132.

Needless to say, the door latch 134 is fixed to rotate by the hinge shaft 138 at the lower end of the door 132, and both ends of a restoring spring 140 are respectively connected to the hinge shaft 138 and the door latch 134 so as to bias the door latch 134 toward the ground.

Moreover, an outer surface 142a of the hook 142 is slanted at an angle such that the hook 142 slides with respect to and is locked by the locking protrusion (not shown).

Meanwhile, the door latch 134 employed in the coil nailer 100 according to the preferred embodiment of the present invention can perform the release of the door latch 134 and the opening of the door 132 at once when opening the door 132, and has a structure capable of preventing the door 132 from opening due to vibration when the coil nail gun 100 is fired.

In other words, when the coil nailer 100 fires nails (not shown) loaded in a magazine 110, the recoil is applied in the longitudinal direction of the body 104, wherein the recoil and the counter-recoil are applied in the direction of the muzzle 114 and in the counter direction of the muzzle 114, respectively.

Thus, in the conventional coil nailer 2, when the operation direction for locking and releasing is aligned with the direction of the recoil like the case of the door latch 20, the door 16 is easily opened due to the recoil.

However, in the door latch 134 employed in the coil nailer 100 according to the preferred embodiment of the present invention, since the operation direction of the door latch 134 is vertical, the operation direction is perpendicular to the direction of the recoil so that the door latch 134 is not released due to the recoil. Thus, the door 132 is not easily opened due to the recoil.

The door latch structure of the present invention is designed in consideration of the fact that accidents frequently occur when the door 132 is opened due to impact when using the coil. Since the door latch structure is directly related to prevent the accident and to enhance convenience, the door latch structure is very effective.

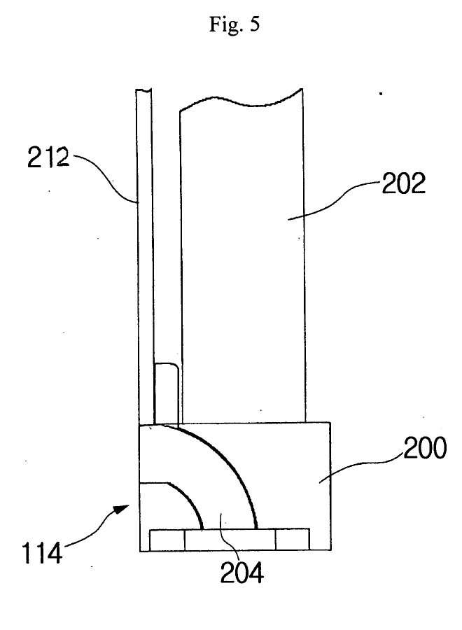

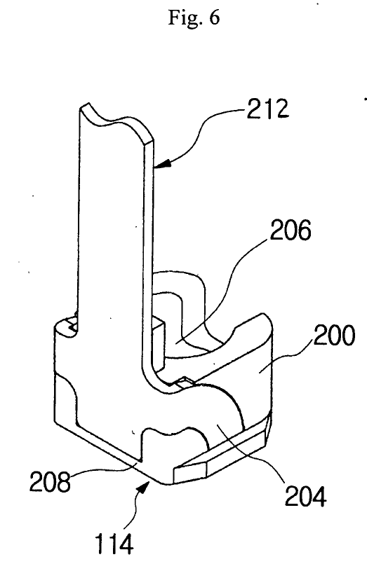

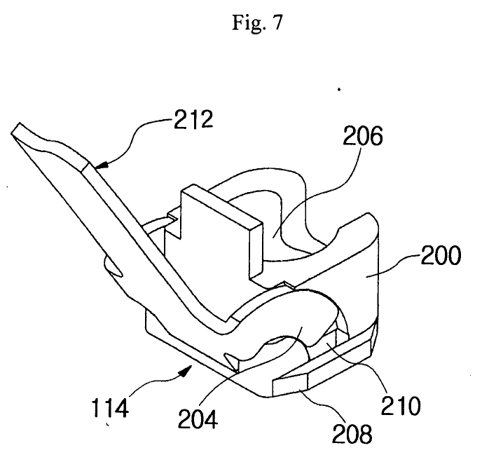

FIG. 5 is a view illustrating a coupling structure of a connector of the coil nailer according to the preferred embodiment of the present invention, FIG. 6 is a perspective view illustrating the coupling structure of the connector of the coil nailer according to the preferred embodiment of the present invention, and FIG. 7 is a perspective view illustrating operation of the connector of the coil nailer according to the preferred embodiment of the present invention.

The muzzle 114 employed in the coil nailer according to the preferred embodiment of the present invention is now described with reference to the above respective drawings. The muzzle 114 is a member formed in the front end of a nose 202 as a front member for guiding and firing nails or needles loaded in the coil nailer, and is characterized by the coupling structure.

In other words, in the coil nailer 100 according to the preferred embodiment of the present invention, a coupling part 206 of a coupling member 200 is coupled with a front outer circumference of the nose 202, and a contact arm 212 and a contactor 200 which are positioned in the longitudinal direction are respectively coupled with the upper side of the nose 202.

The contactor 200 has coupling grooves 210 formed in the lateral sides of the contactor 200, and the contact arm 212 has a coupling part 204 formed to have a leg-shape by splitting the front end of the contact arm 212 and coupled with the coupling grooves 210.

Thus, according to the present invention, the contact arm 212 and the contactor 200 are easily coupled to and separated from one another. In other words, the present invention has a structure wherein, in order to prevent the contactor 200 from separating from the contact arm 212 or the nose 202 when the contact arm 212 and the contactor 200 are coupled with each other such that the contact 200 closely contacts an impacting position in order to fire the coil nailer, or the coil nailer is vibrated, the contactor 200 is not separated from the contact arm 212 in the state of fixing the contact arm 212 regardless of the moving direction when the contact arm 212 is coupled with the contactor 200.

To this end, the coupling part 204 of the contact arm 212 is bent in an arc-shape, and the coupling part of the contactor 200 is bent in an arc-shape to accommodate the coupling part 204 of the contact arm 212.

Thus, according to the present invention, when the contact arm 212 is lifted from the coupling position where the contact arm 212 and the contactor 200 are coupled with each other, the contact arm 212 is not separated from the contactor 200 so that stability is secured and the contactor 200 is easily replaced when the contactor 200 is worn and replaced.

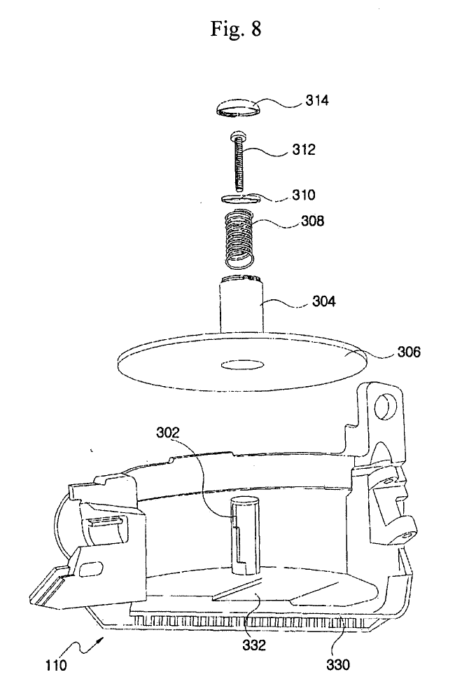

FIG. 8 is an exploded perspective view illustrating the magazine of the coil nailer according to the preferred embodiment of the present invention.

Referring to the above drawing, the magazine 110 employed in the coil nailer according to the preferred embodiment of the present invention precisely guides the nails by moving a guiding device in the magazine in the state of loading various sized nails therein, and includes a measuring device installed to the lower side of the magazine 110 to measure intervals between shingles and a device for adjusting the length of the measuring device and fixing the measuring device so that the striking of the coil nailer can be performed with both hands.

In other words, the magazine employed in the coil nailer 100 according to the preferred embodiment of the present invention includes a height adjustor for adjusting the height of an inner platform 304 as a support for supporting the nails according to the length of nails loaded in the magazine 110 so as to load and guide the nails regardless of the length of the nails, and a shingle interval measuring device for easily measuring a distance between a lower waterproof sheet and an upper waterproof sheet when fastening the waterproof sheets.

Referring to FIG. 8, the height adjustor employed in the magazine 110 of the coil nailer according to the preferred embodiment of the present invention will now described.

The magazine 110 of the coil nailer 100 according to the preferred embodiment of the present invention is made of a cylinder such that coil is wound therearound in concentric circles and includes a winding shaft of the coil as a magazine post 302 installed at the inner center of the magazine 110.

The magazine post 302 has a plurality of grooves in the outer circumference and the inner platform 304 hung around the outer circumference of the magazine post 302 to support the lower side of the coil.

The inner platform 304 has a hollow part into which the magazine post 302 is inserted and a supporting plate 306 attached to the lower side of the inner platform 304 such that the coil coupled with the nails is placed on the upper side of the supporting plate 306.

In the hollow part of the inner platform 304, a spring 308 is disposed to apply restoring force to the inner platform 304 toward the bottom surface of the magazine 110, and in the upper side of the inner platform 304, a ring plate 310 is coupled such that the restoring force of the spring 308 is applied to a fixed bolt 312.

In the hollow part of the inner platform 304, a long bolt 312 fastened into a groove formed in the center of the magazine post 302 is provided to support the inner platform 304, and thereabove, a cap for 314 for closing the upper side of the inner platform 304 is provided.

According to the present invention, when the inner platform 304 is fixed to the magazine post 302 fixed to the inner bottom center of the magazine 110, the inner platform 304 is lifted from the bottom of the magazine 110 by a predetermined height and can be fixed at the predetermined height according to whether the inner platform 304 is fixed to a groove of the magazine post 302. Thus, since the coil to which a plurality of nails is connected is loaded on the upper side of the inner platform 304, the height of the inner platform 304 is freely adjusted according to the length of the nails and the loaded nails can be precisely guided due to the adjustment of the height of the inner platform 304.

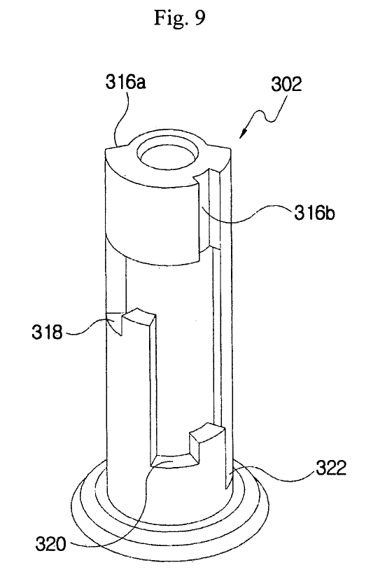

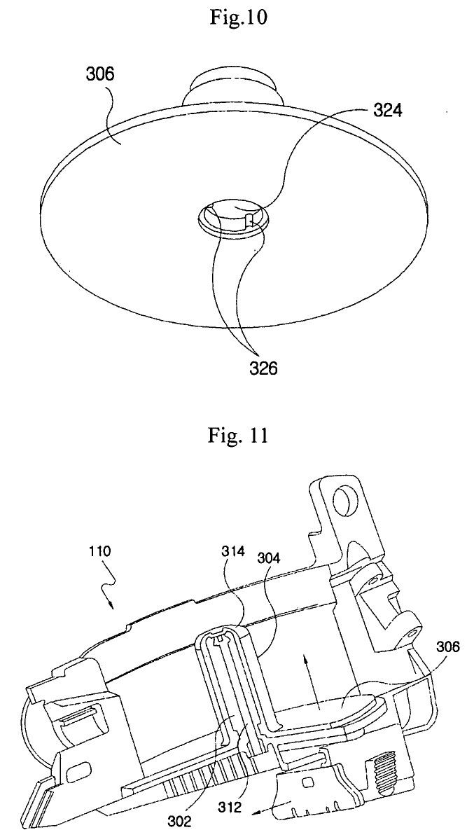

FIG. 9 is a partially enlarged perspective view illustrating the magazine post of the coil nailer according to the preferred embodiment of the present invention, FIG. 10 is a bottom perspective view illustrating the coil supporting plate of the coil nailer according to the preferred embodiment of the present invention, and FIG. 11 is a partially cut-away perspective view illustrating the magazine of the coil nailer according to the preferred embodiment of the present invention.

As shown in the drawings, the magazine post 302 employed in the coil nailer according to the preferred embodiment of the present invention is a device that is fixed to the bottom of the magazine 110 and adjusts the height of the inner platform 304. The magazine post 302 includes a hollow part for accommodating the bolt 312 therein, a plurality of guide grooves 316a and 316b formed in the outer circumference in the longitudinal direction, a first insertion groove 318, a second insertion groove 320, and a third insertion groove 322 formed in the horizontal direction of the guide grooves 316a and 316b and having different heights.

The first insertion groove 318 is formed at the highest position along the guide grooves 316a and 316b, the third insertion groove 322 is formed at the lowest position along the guide grooves 316a and 316b, and the second insertion groove 320 is formed between the first insertion groove 318 and the third insertion groove 322.

Meanwhile, the inner platform 304 had a hollow part 324 formed therein, the supporting plate 306 attached to the lower side of the inner platform 304 to place the coil thereon, and protrusions 326 formed in the inner circumference of the hollow part 324 in the guide grooves 316a and 316b.

Thus, according to the present invention, as shown in FIG. 11, when the coil to which the nails are connected is loaded on the upper side of the supporting plate 306 and the inner platform 304 is lifted, the restoring force moving the inner platform 304 toward the bottom of the magazine 110 is applied to the inner platform 304 due to the tensile force of the spring 308 in the inner platform 304.

The worker overcomes the force and rotates the inner platform 304 to a proper position in the horizontal direction, then the protrusions 126 are inserted into one of the first, second, and third insertion grooves 318, 320, and 322, for example into the first insertion groove 318.

In this state, although the external force applied to the inner platform 304 by the worker is removed, since the protrusions 326 of the inner platform 304 are placed in the insertion groove 320, the inner platform 304 does not descend toward the bottom of the magazine 110 and is fixed to the position of the magazine post 302 having the second insertion groove 320.

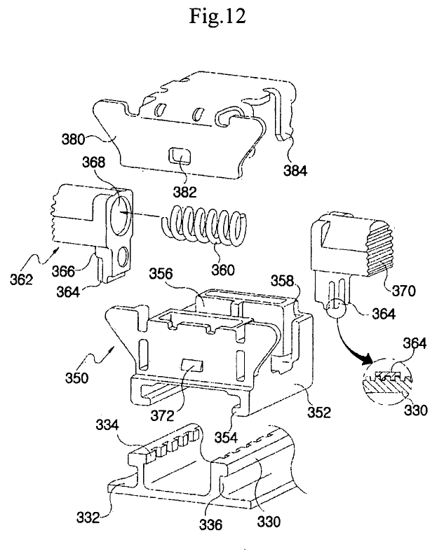

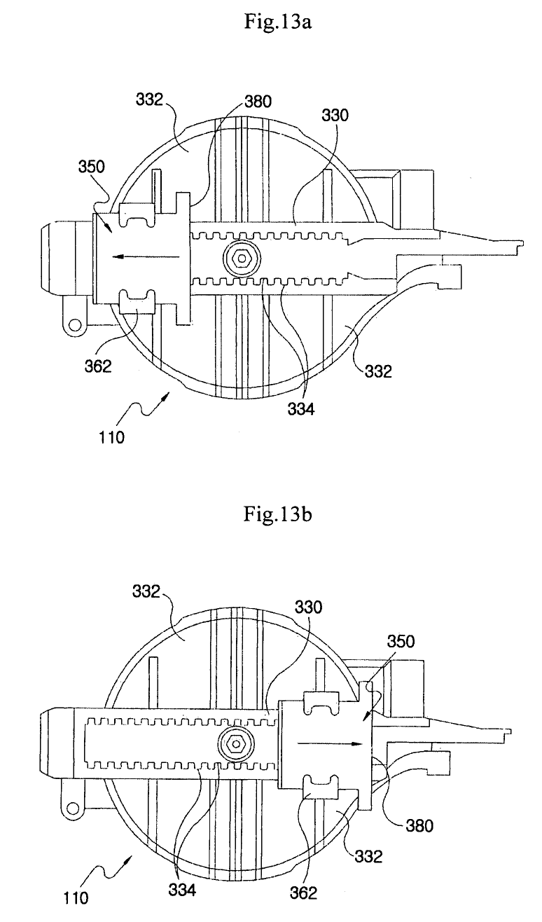

FIGS. 12, 13a, and 13b are an exploded perspective view illustrating the shingle-interval adjusting device of the coil nailer according to the preferred embodiment of the present invention, and views illustrating the use of the shingle-adjusting device of the coil nailer according to the present invention.

Described with reference to the drawings, the shingle interval adjusting device employed in the coil nailer according to the preferred embodiment of the present invention is a device for measuring intervals between shingles added to the coil nailer 100, and is installed to the lower side 132 of the magazine 310.

In other words, guide rails 330 formed with a plurality of protrusions 334 in the longitudinal direction are attached to the lower inner side 332 of the magazine 110, and recessive steps 336 are formed in the lower outer lateral sides of the guide rails 330.

Moreover, an adjusting member 350 is provided such that the adjusting member 350 is engaged with the guide rails 330, moves along the guide rails 330 in the longitudinal direction, and is fixed to a proper position by the worker. The adjusting member 350 includes an adjusting member body 352 for accommodating a plurality of parts and a slider 354 formed in the lower side of the body 352 and coupled with the recessive steps 336 to be slid.

The adjusting member body 352 includes a first insertion groove 356, formed from the upper side to the inner side thereof, into which a spring 360 and engaging protrusions 364 are inserted, and second insertion grooves 358 formed in the front and rear sides of the first insertion groove 356 and engaged with coupling protrusions 384 of an adjusting plate 380.

Meanwhile, operating levers 362 are respectively inserted into the front and rear sides of the first insertion groove 356 formed in the adjusting member body 352 and a restoring force is applied to the operating levers 362 in the opposite direction by the spring 360. Each of the operating levers 362 has a protrusion rod 366 inserted into the first insertion groove 356 and uneven engaging protrusions 364 formed in the inner wall of the protrusion rod 366.

The uneven engaging protrusions 364 are engaged with the protrusions 334 of the guide rails 330 to fix the adjusting member body 352 to a proper position, and each of the operating levers 362 has an insertion hole 368, formed in the opposite surface, into which the spring 360 is inserted.

Moreover, the adjusting plate 380 is coupled with the upper side of the adjusting member body 352 when the operating levers 362 and the spring 360 are respectively coupled with the adjusting member body 352, fixes the operation levers 362 and the spring 360, and measures the distance. The adjusting plate 380 has a through-hole 382, formed in the front side of the adjusting plate 380, into which a protrusion 372 formed in the front side of the adjusting member 352 is inserted, and a coupling protrusion 384 formed in the lower rear side of the adjusting member body 352 and inserted into the second insertion groove 358.

Thus, when the operation levers 362 and the spring 360 are coupled with the adjusting member body 352 and the adjusting plate 380 is coupled with the upper side of the adjusting member body 352, the operation levers 362 and the spring 360 are not separated.

In this state, when the operation levers 362 are pushed in the opposite direction, the spring 360 is compressed and the engaging protrusions 364 formed in the lower sides of the operation levers 362 are separated from the protrusions 334 of the guide rails 330.

In the state of pressing the operation levers 362, as shown in FIG. 13b, when the adjusting member body 352 is moved at a predetermined distance and the external force applied to the operation levers 362 are removed, the operation levers 362 move in the opposite direction due to the restoring force of the spring 360 in the operation levers 362 so that the engaging protrusions 364 are engaged with the protrusions 334 of the guide rails 330.

Then, through the distance between the muzzle 114 of the coil nailer as shown in FIG. 2 and the adjusting plate 380, the waterproof sheets (not shown) attached to the surface of the roof can be attached at regular intervals.

In other words, since the distance between the muzzle 114 and the adjusting plate 380 is fixed in a state of moving the adjusting member 350 at a predetermined distance and fixing the same, when one waterproof sheet is attached in the column direction and another waterproof sheet covering a part of the attached waterproof sheet is attached, the muzzle 114 is positioned at the end of the lower waterproof sheet and the upper waterproof sheet can be attached to correspond to the adjusting plate 380. Thus, a measuring tape is unnecessary, and the waterproof sheets can be attached while holding the heavy coil nailer 100 with both hands and precisely measuring length.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

As described above, according to the coil nailer for construction finish material of the present invention, since the releasing direction of the door latch is aligned with the opening direction of the door, the door latch is released when the door is opened so that the door is conveniently opened. Since the operating direction of the door latch is perpendicular to the direction of the recoil, the door cannot be opened due to the recoil.

Moreover, since the plate for supporting the nails in the magazine according to the length of the nails loaded in the magazine is lowered or lifted according to the length of the nails, the nails can be effectively guided, the interval between the lower waterproof sheet and the upper waterproof sheet can be measured when attaching the shingles and the waterproof sheets. Since the measuring device capable of adjusting the measuring position is installed in the lower side of the magazine, a scale does not need so that the coil nailer can be simplified and a worker can freely fasten.

Additionally, according to the present invention, the contactor for preventing the contacting portion of the muzzle positioned at the front side of the coil nailer from being worn can be securely and easily coupled without bolting or welding, and the coupling and the separation are very convenient so that the replacement of the contactor is easy.

What is claimed is:

1. A coil nailer comprising:
a body in which a piston and a cylinder are installed;
a magazine including a supply passage for supplying air to the piston, a handle grasped by a hand, and a magazine, installed to the front lower side of the body, in which nails, staples, or pins are loaded;
a standby part for receiving the nails, staples, or the pins loaded in the magazine and for keeping the nails, the staples, or the pins waiting for firing through a muzzle positioned at the front side of the body;
a door installed at the lower side of the front standby part of the body and opened to visually check the nails, the staples, or the pins supplied from the magazine; and
a door latch installed in the lower side of the door to lock a hook formed at the other end of the door latch with respect to a locking protrusion in order to keep the door closed;
wherein a hinge shaft of the door latch is aligned with a hinge shaft of the door so that the operation direction of the door latch is identical to the opening and closing direction of the door and the release of the door latch and the opening of the door are simultaneously carried out.

2. The coil nailer as set forth in claim 1, wherein the operation direction of the door latch is perpendicular to the direction of a recoil force of firing the nails so that the door is prevented from opening due to the recoil force;
the hinge shaft of the door latch is connected to a coil spring; and
ends of the coil spring are respectively connected to the door latch and the hinge shaft so that the door latch is biased toward the ground.

3. The coil nailer as set forth in claims 1, wherein the door latch is installed to be operated in the vertical direction so that the hinge shaft of the door latch and a hinge shaft of a check pawl, formed in the central portion of the door, through which whether nails are loaded is checked can be implemented by a single hinge shaft, whereby reducing the number of parts.

4. A coil nailer comprising:
a nose as a front member for guiding and firing nails and needles loaded therein; and
a contactor coupled with a front outer circumference of the nose by the inside of a body of the contactor and including a coupling part of a contact arm positioned on the nose coupled with coupling grooves formed in the lateral sides of the contactor such that the contact is easily coupled and separated.

5. The coil nailer as set forth in claim 4, wherein the coupling part of the contact arm is bent in an arc-shape, and the coupling groove of the contactor is bent in an arc-shape to accommodate the coupling part of the contact arm.

6. A coil nailer comprising:
a height adjustor for adjusting the height of an inner platform as a support for supporting nails according to the length of the nails loaded in a magazine so as to load and guide the nails regardless of the length of the nails; and
a shingle interval measuring device for easily measuring distance between a lower shingle and an upper shingle when fastening the shingles as waterproof materials for a roof,
wherein various sized nails are precisely loaded in the magazine and the intervals between the shingles or the shingles are easily adjusted.

7. The coil nailer as set forth in claim 6, wherein the height adjustor comprises:
a magazine made of a cylinder around which a coil is wound in the concentric circles;
a winding shaft of the coil as a magazine post installed at the inner center of the magazine;
the magazine post having a plurality of grooves in the outer circumference;
wherein the inner platform is hung around the outer circumference of the magazine post to support the lower side of the coil, and comprises a hollow part into which the magazine post is inserted, and a supporting plate attached to the lower side of the inner platform such that the nails are placed on the upper side of the supporting plate.

8. The coil nailer as set forth in claim 6, wherein the inner platform comprises:
a spring installed in the hollow part to apply a restoring force to the inner platform toward the bottom surface of the magazine;
a spring installed in the upper side of the inner platform;
a bolt for fixing the inner platform on the bottom of the magazine; and
a cap for closing the upper side of the inner platform.

9. The coil nailer as set forth in claim 7, wherein the magazine post comprises:
a hollow part for accommodating the bolt;
a plurality of guide grooves formed in the longitudinal direction of the outer circumference thereof; and
first, second, and third placing grooves formed in the horizontal direction of the guide grooves and having different heights.

10. The coil nailer as set forth in claim 7, wherein the inner platform comprises:
a hollow part formed in the inner platform;
a supporting plate formed in the lower side of the inner platform to place a coil on the supporting plate; and
first, second, and third protrusions formed in the inner circumference of the hollow part, guided along the guide grooves, and inserted into the first, second, and third placing grooves such that the height of the inner platform is adjusted.

11. The coil nailer as set forth in claim 7, wherein the shingle interval measuring device comprises:
guide rails formed in the lower side of the magazine and formed with a plurality of protrusions in the longitudinal direction;
recessive steps formed in the outer lower lateral sides of the guide rails; and
an adjusting member engaged with the guide rails, moving along the guide rails in the longitudinal direction, and fixed to a proper position by a worker.

12. The coil nailer as set forth in claim 11, wherein the adjusting member comprises:
a body for accommodating a plurality of parts;
a slider formed in the lower side of the body and coupled with the recessive steps to be slid;
a first insertion groove, formed from the upper side to the inside thereof, into which a spring and engaging protrusions are inserted;
second insertion grooves formed in the front and rear sides of the first insertion groove and engaged with coupling protrusions of an adjusting plate;
operating levers respectively inserted into the front and rear sides of the first insertion groove formed in the body of the adjusting member and applied by a restoring force in the opposite direction by the spring;
protrusion rods formed in the lower sides of the operating levers and inserted into the first insertion groove;
uneven engaging protrusions formed in the inner wall of the protrusion rods; and
insertion holes formed in the opposite surfaces of the operating levers to accommodate the spring.

13. The coil nailer as set forth in claim 12, wherein the body of the adjusting member comprises:
an adjusting plate coupled with the upper side of the body of the adjusting member to fix the operating levers and the spring and to measure distance;
a through-hole formed in the front side of the adjusting plate and coupled with a protrusion formed in the front side of the body of the adjusting member; and
a coupling protrusion formed in the lower rear side of the body of the adjusting member and inserted into the second insertion groove.
